(19) United States
(12) Patent Application Publication
(10) Pub. No.: US 2017/0012339 A1
(43) Pub. Date: Jan. 12, 2017

(54) ANTENNA DEVICE AND ELECTRONIC APPLIANCE

(71) Applicant: Murata Manufacturing Co., Ltd., Nagaokakyo-shi (JP)

(72) Inventors: Hiromitsu ITO, Nagaokakyo-shi (JP); Isamu MORITA, Nagaokakyo-shi (JP)

(21) Appl. No.: 15/271,503

(22) Filed: Sep. 21, 2016

Related U.S. Application Data
(63) Continuation of application No. PCT/JP2016/052076, filed on Jan. 26, 2016.

(30) Foreign Application Priority Data
Jan. 30, 2015 (JP) 2015-017185

(51) Int. Cl. H01Q 1/22; H01Q 7/00; H01Q 1/36

(52) U.S. Cl. CPC H01Q 1/2208; H01Q 1/36; H01Q 7/00

(57) ABSTRACT

An antenna device includes an insulating substrate, a spiral-shaped coil conductor on a main surface of the substrate, and a routing member with first and second connection portions electrically connected to each other. At least a portion of the routing member between the first connection portion and the second connection portion faces the coil conductor. At least either of the first connection portion and the second connection portion of the routing member is connected to an inner peripheral portion or an outer peripheral portion of the coil conductor via a conductive joining material. Thus, the routing member is mounted using a conductive joining material and is surface mounted in the same way as a typical surface mount device such as an RFIC element.

### CROSS REFERENCE TO RELATED APPLICATIONS

This application claims the benefit of priority to Japanese Patent Application 2015-017185 filed Jan. 30, 2015 and is a Continuation Application of PCT/JP2016/052076 filed on Jan. 26, 2016. The entire contents of each application are hereby incorporated by reference.

### BACKGROUND OF THE INVENTION

1. Field of the Invention

The present invention relates to an antenna device preferably for use in a HF-band communication system and a power transmission system, and relates to an electronic appliance.

2. Description of the Related Art

To date, an antenna device that includes an antenna coil that is formed of a spiral-shaped conductor pattern that is provided on the surface of a substrate has been implemented, as described in Japanese Unexamined Patent Application Publication No. 2014-220016.

When such an antenna device is to be connected to an RFID wireless IC chip and an external circuit, terminals, which are connected to an inner peripheral end and an outer peripheral end of the antenna coil, are typically disposed so as to be close to each other and aligned with each other. Consequently, a configuration in which the inner peripheral end of the antenna coil (inner peripheral end of spiral-shaped conductor pattern) is routed to a region outside the spiral shape or a configuration in which the outer peripheral end of the antenna coil (outer peripheral end of spiral-shaped conductor pattern) is routed to a region inside the spiral shape is adopted.

Japanese Unexamined Patent Application Publication No. 2014-220016 discloses a method of manufacturing an antenna device that includes a spiral-shaped antenna coil that is provided on one surface of a substrate and a bridge pattern that is provided on the other surface of the substrate (a surface on the opposite side to the one surface). The bridge pattern is joined to a terminal of an outer peripheral end and a terminal of an inner peripheral end of the antenna coil. In other words, the bridge pattern connects the terminal of the outer peripheral end and the terminal of the inner peripheral end of the antenna coil to each other via a through hole that is provided in the substrate.

However, in the manufacturing method disclosed in Japanese Unexamined Patent Application Publication No. 2014-220016, a process is required in which the bridge pattern is pressed against and welded to the antenna coil (coil conductor) and therefore the manufacturing process is complicated. Furthermore, it is easy for a manufacturing defect to occur such as one in which the substrate melts when the welding is performed and becomes stuck to the device used to manufacture the antenna device.

In addition, in the case where the antenna coil (coil conductor) provided on the one surface of the substrate and the bridge pattern provided on the other surface of the substrate are connected to each other via a through hole or the like, processes in which a through hole is formed in the substrate, the through hole is filled with a conductive material and so forth, are needed and therefore the manufacturing process is complicated.

### SUMMARY OF THE INVENTION

Preferred embodiments of the present invention provide an antenna device in which an inner peripheral portion and an outer peripheral portion of a spiral-shaped coil conductor, which is provided on a main surface of a substrate, are able to be connected to each other using a simple structure and process, and provide an electronic appliance that includes such an antenna device.

An antenna device according to a preferred embodiment of the present invention includes a substrate that has an insulating property; a spiral-shaped coil conductor provided on at least one main surface of the substrate; and a routing member that includes a conductor in at least a portion thereof and a first connection portion and a second connection portion that are electrically connected to each other; wherein at least a portion of the routing member between the first connection portion and the second connection portion faces the coil conductor and the first connection portion is connected to an inner peripheral portion or an outer peripheral portion of the coil conductor via a conductive joining material.

With this configuration, the routing member, which connects the inner peripheral portion and the outer peripheral portion of the coil conductor to each other, is mounted (disposed) using a conductive joining material and therefore is able to be surface mounted in the same way as a typical surface mount device such as an RFIC element. Therefore, there is no need for a process such as pressing the routing member against the coil conductor and welding the routing member to the coil conductor. Therefore, an antenna device is provided in which the inner peripheral portion and the outer peripheral portion of the spiral-shaped coil conductor, which is provided on a main surface of the substrate, are able to be connected to each other using a simple structure and process.

A structure is able to be adopted in which the first connection portion is connected to the inner peripheral portion of the coil conductor via a conductive joining material and the second connection portion is connected to the outer peripheral portion of the coil conductor via a conductive joining material.

It is preferable that the routing member include a flat metal plate. With this configuration, there is no need to provide a conductor separate from the routing member and therefore the manufacturing process is simple and a cost reduction is achieved.

It is preferable that the routing member be arranged such that a surface thereof, which is on the opposite side to a surface thereof where a protrusion is provided at a time of processing, faces the coil conductor. With this configuration, a protrusion at an edge of the routing member does not contact the coil conductor. Therefore, the occurrence of a problem such as breaking, severing or short circuiting of the coil conductor caused by the protrusion contacting the coil conductor is significantly reduced or prevented.

It is preferable that a groove be provided in at least a portion of the routing member between the first connection portion and the second connection portion. With this configuration, spreading of the conductive joining material into a region between the first connection portion and the second connection portion is significantly reduced or prevented. Therefore, a decrease in the amount of the conductive joining material that is between the first connection portion and the coil conductor and that is between the second connection portion and the coil conductor (or conductor connected to the coil conductor) is prevented. Therefore, it is possible to maintain high strength of the joint between the first connection portion and the coil conductor and the strength of the joint between the second connection portion and the coil conductor (or conductor connected to the coil conductor).

It is preferable that at least the first connection portion and the second connection portion have a relatively high wettability to the conductive joining materials compared to a region between the first connection portion and the second connection portion. With this configuration, spreading of the conductive joining material into a region between the first connection portion and the second connection portion is significantly reduced or prevented. Therefore, a decrease in the amount of the conductive joining material that is between the first connection portion and the coil conductor and that is between the second connection portion and the coil conductor (or a conductor connected to the coil conductor) is prevented. Therefore, it is possible to maintain high strength of the joint between the first connection portion and the coil conductor and the strength of the joint between the second connection portion and the coil conductor (or a conductor connected to the coil conductor).

It is preferable that a plating layer be provided on the first connection portion and the second connection portion. With this configuration, the first connection portion and the second connection portion, which have relatively high wettability to the conductive joining materials compared to the region between the first connection portion and the second connection portion, are easily formed.

It is preferable that the routing member include a substrate layer that has a similar coefficient of linear expansion to the substrate and that a conductor be provided on a surface of the routing member that faces the coil conductor. If the coefficient of linear expansion of the routing member and the coefficient of linear expansion of the substrate are different from each other, the routing member will warp when the conductive joining materials are heated, but this problem is prevented with this configuration. Therefore, contact defects and shorts between the first connection portion and the coil conductor and between the second connection portion and the coil conductor are significantly reduced or prevented and the yield when manufacturing the antenna device is increased.

It is preferable that an insulating layer be provided on at least a portion of the routing member between the first connection portion and the second connection portion. With this configuration, spreading of the conductive joining material into a region between the first connection portion and the second connection portion is significantly reduced or prevented. Therefore, a decrease in the amount of the conductive joining material that is between the first connection portion and the coil conductor and between the second connection portion and the coil conductor is prevented. Therefore, it is possible to maintain high strength of the joint between the first connection portion and the coil conductor and the strength of the joint between the second connection portion and the coil conductor.

It is preferable that the antenna device further include a surface mount device that is electrically connected to the coil conductor via a conductive joining material. With this configuration, a circuit that performs matching between an external circuit and the coil conductor or that sets a resonant frequency is easily formed, and an external circuit is able to be omitted or simplified.

It is preferable that the antenna device further include an adhesive layer that is positioned between the routing member and the coil conductor; and another member, which is a member other than the adhesive member, that is positioned between the routing member and the coil conductor; and that the adhesive layer be made of a material that has a lower dielectric constant than the other member. With this configuration, changes in characteristics that occur with variations in the thickness of the adhesive member are significantly reduced or prevented.

It is preferable that an electronic appliance according to a preferred embodiment of the present invention include the antenna device according to any of the above-described preferred embodiments of the present invention; and a feeder circuit that is connected to or is electromagnetically coupled with the coil conductor. With this configuration, an electronic appliance that includes an antenna device that may preferably be used in a HF band communication system or a power transmission system is provided.

According to various preferred embodiments of the present invention, an antenna device in which an inner peripheral portion and an outer peripheral portion of a spiral-shaped coil conductor, which is provided on a main surface of a substrate, are able to be connected to each other using a simple structure and process, and an electronic appliance that includes such an antenna device, are provided.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1A is a plan view of an antenna device 101 according to a first preferred embodiment of the present invention and FIG. 1B is a plan view of a conductor pattern that is included in the antenna device 101.

FIG. 2 is an exploded perspective view of the antenna device 101.

FIG. 3A is a bottom surface view of a routing member 21 and FIG. 3B is a sectional view taken along A-A in FIG. 1.

FIG. 4A is a plan view of an antenna device 102 according to a second preferred embodiment and FIG. 4B is a sectional view taken along B-B in FIG. 4A.

FIG. 5A is a plan view of an antenna device 103A and FIG. 5B is a plan view of an antenna device 103B according to a third preferred embodiment of the present invention.

FIG. 6A is a rear surface view of a routing member 24 according to fourth preferred embodiment of the present invention, FIG. 6B is a sectional view of the routing member 24 and FIG. 6C is a sectional view of a mounting portion of the routing member 24.

FIG. 7 is a sectional view of a comparative example and illustrates a mounting portion of a routing member 24A in which grooves are not formed.

FIG. 8A is a rear surface view of a routing member 25A according to a fifth preferred embodiment of the present invention, FIG. 8B is a sectional view of the routing member 25A and FIG. 8C is a sectional view of a mounting portion of the routing member 25A.

FIG. 9A is a rear surface view of a routing member 25B according to the fifth preferred embodiment, FIG. 9B is a sectional view of the routing member 25B and FIG. 9C is a sectional view of a mounting portion of the routing member 25B.

FIG. 10A is a rear surface view of a routing member 26 according to a sixth preferred embodiment of the present invention, FIG. 10B is a sectional view of the routing member 26 and FIG. 10C is a sectional view of a mounting portion of the routing member 26.

FIG. 11A is a rear surface view of a routing member 27 according to a seventh preferred embodiment of the present invention, FIG. 11B is a sectional view of the routing member 27 and FIG. 11C is a sectional view of a mounting portion of the routing member 27.

FIG. 12A is a plan view of an antenna device 108 according to an eighth preferred embodiment of the present invention and FIG. 12B is a rear surface view of a routing member 28 according to the eighth preferred embodiment. FIG. 12C is a sectional view taken along C-C in FIG. 12A.

FIG. 13A is a plan view of an antenna device 109 according to a ninth preferred embodiment of the present invention, FIG. 13B is a rear surface view of a routing member 29 according to the ninth preferred embodiment and FIG. 13C is a sectional view of a mounting portion of the routing member 29.

FIG. 14 is a plan view illustrating the structure inside a casing of an electronic appliance according to a tenth preferred embodiment of the present invention.

FIG. 15 is a plan view illustrating the structure inside a casing of an electronic appliance according to an eleventh preferred embodiment of the present invention.

### DETAILED DESCRIPTION OF THE PREFERRED EMBODIMENTS

Hereafter, preferred embodiments of the present invention will be described by giving a number of specific examples while referring to the drawings. In the drawings, like symbols denote like portions. Each preferred embodiment is an illustrative example and elements of the configurations described in different preferred embodiments can be substituted for one another or combined with each other.

In each of the preferred embodiments described hereafter, the term “antenna device” refers to an antenna that radiates magnetic flux. The antenna device preferably is an antenna that is used to perform near field communication in which magnetic field coupling with the antenna of a communication partner is utilized and is used in near field communication (NFR), for example. The frequency band that is used by the antenna device preferably is a HF band, for example, and the antenna device is particularly used at 13.56 MHz or frequencies in the vicinity of 13.56 MHz, for example. The size of the antenna device is very small compared with the wavelength λ at the used frequency and the radiation characteristics of electromagnetic waves in the used frequency band are poor. The size of a coil antenna included in the antenna device preferably is about λ/10 or less, for example. Here, the term wavelength refers to the effective wavelength taking into consideration a wavelength shortening effect due to a dielectric property and magnetic permeability of a substrate on which the antenna is formed. The two ends of a coil conductor of the coil antenna are connected to a feeder circuit that operates in the used frequency band (HF band, particularly 13.56 MHz or in vicinity of 13.56 MHz, for example).

### First Preferred Embodiment

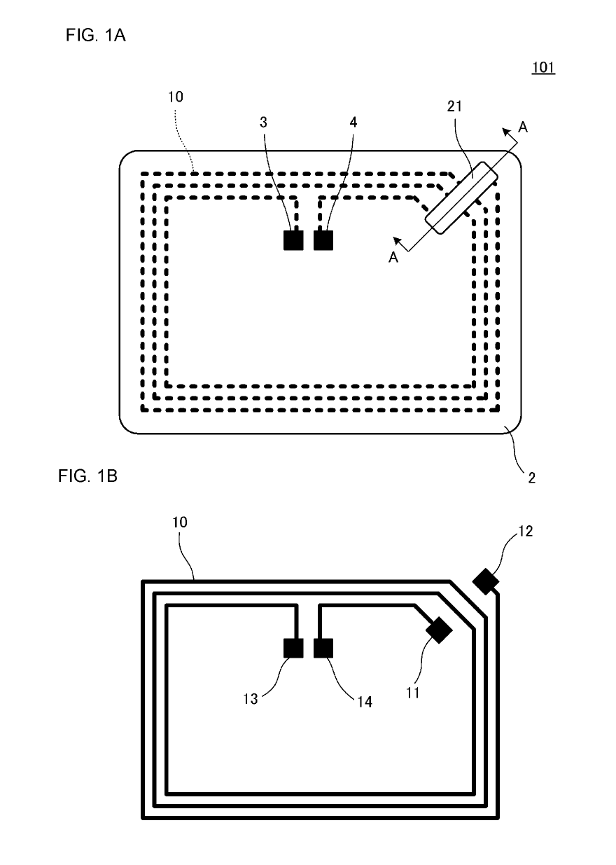

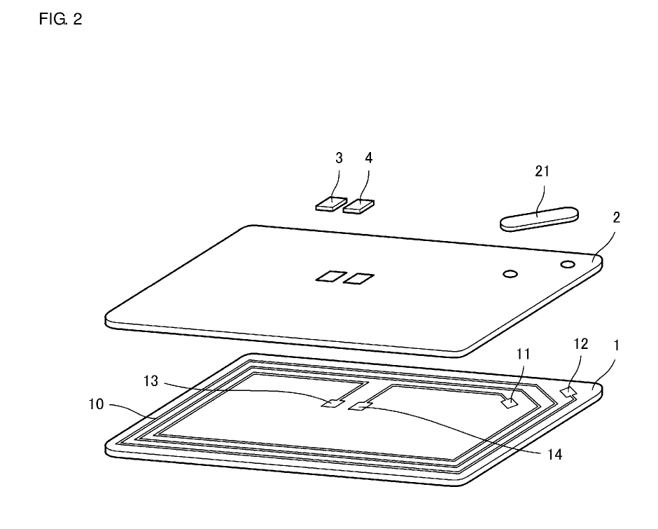

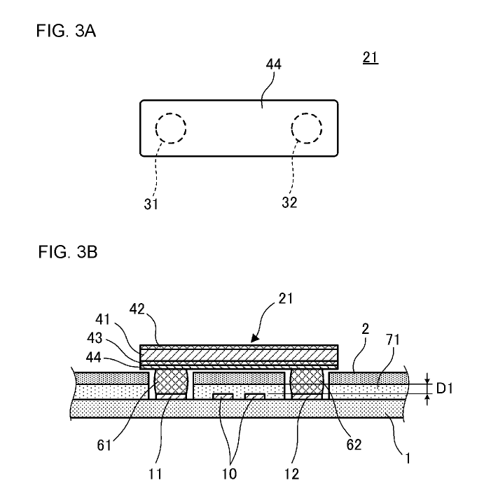

FIG. 1A is a plan view of an antenna device 101 according to a first preferred embodiment of the present invention and FIG. 1B is a plan view of a conductor pattern that is included in the antenna device 101. FIG. 2 is an exploded perspective view of the antenna device 101. Illustration of an adhesive layer 71 is omitted from FIG. 2. FIG. 3A is a bottom surface view of a routing member 21 and FIG. 3B is a sectional view taken along A-A in FIG. 1. FIG. 3A and FIG. 3B illustrate the structure of the routing member 21 in a simplified manner in order to enable easy understand of the drawings and principles. In addition, in FIG. 3B, the thickness of each element or portion is illustrated in an exaggerated manner. The same also applies to the sectional views referred to in all the preferred embodiments hereafter.

The antenna device 101 includes a substrate 1, a coil conductor 10, a protective layer 2, the adhesive layer 71, a first external connection terminal plate 3, a second external connection terminal plate 4 and the routing member 21. The substrate 1 preferably is a rectangular or substantially rectangular flat board composed of an insulating material such as a resin. The substrate 1 is, for example, a resin sheet such as a polyimide, polyethylene terephthalate (PET) or liquid crystal polymer (LCP) sheet and a Young's modulus EB of the substrate 1 is about 3 GPa, for example.

The coil conductor 10 is a spiral-shaped thin metal plate that is provided on one main surface (upper surface in FIG. 3B) of the substrate 1 and includes a Cu foil or Al foil, for example. The coil conductor 10 includes a first connection terminal 11, a second connection terminal 12, a first external connection terminal 13 and a second external connection terminal 14.

In this preferred embodiment, the first connection terminal 11 preferably has a square or substantially square planar shape and is a conductor pattern that is provided at an inner peripheral end of the coil conductor 10. The second connection terminal 12 has a square or substantially square planar shape and is a conductor pattern that is provided at an outer peripheral end of the coil conductor 10. In the antenna device 101 according to this preferred embodiment, the first connection terminal 11 and the second connection terminal 12 are disposed close to one corner (top right corner in FIG. 1) of the antenna device 101.

In the specification of the present application, “the inner peripheral portion of the coil conductor 10” (“inner peripheral portion of coil conductor”) and “the outer peripheral portion of the coil conductor 10” (“outer peripheral portion of coil conductor”) do not only refer to the inner peripheral end of the coil conductor 10 and the outer peripheral end of the coil conductor 10, respectively, and “the inner peripheral portion of the coil conductor 10” and “the outer peripheral portion of the coil conductor 10” respectively refer to an inner peripheral side of the coil conductor 10 and an outer peripheral side of the coil conductor 10 between which at least one turn of the coil conductor 10 is interposed.

The first external connection terminal 13 and the second external connection terminal 14 have square or substantially square planar shapes and are conductor patterns that connect an external circuit such as an RFIC element and the coil conductor 10 to each other. The first external connection terminal 13 and the second external connection terminal 14 are provided midway along or at an end of the coil conductor 10. In the antenna device 101 according to this preferred embodiment, the first external connection terminal 13 and the second external connection terminal 14 are provided midway along the coil conductor 10 and inside a coil opening of the coil conductor 10. The planar shapes of the first connection terminal 11, the second connection terminal 12, the first external connection terminal 13 and the second external connection terminal 14 are not limited to these shapes and may be changed as appropriate.

The protective layer 2 is a rectangular or substantially rectangular flat plate, protects the substrate 1 and the coil conductor 10 from impacts, external forces and the like applied from the outside, and has an insulating property. The protective layer 2 has the same or substantially the same planar shape as the substrate 1 and is affixed to the one main surface of the substrate 1 via the adhesive layer 71. In this preferred embodiment, holes are provided in the protective layer 2 through which the first connection terminal 11, the second connection terminal 12, the first external connection terminal 13 and the second external connection terminal 14 are exposed. The protective layer 2 is a resin layer composed of polyimide or a liquid crystal polymer (LCP), for example. The planar shape of the protective layer 2 is not limited to being the same or substantially the same as that of the substrate 1 and may be changed as appropriate. A relative dielectric constant ε_{P} of the protective layer 2 is about 3.4, for example, and the Young's modulus E_{P} of the protective layer 2 is about 3 GPa, for example.

The adhesive layer 71 has an insulating property and adhesiveness and is provided over substantially the entirety of the surface of the substrate 1. The adhesive layer 71 is a double-sided adhesive sheet, a layer composed of an adhesive agent or a layer composed of polytetrafluoroethylene (PTFE), for example. The adhesive layer 71 is not limited to being provided over substantially the entire surface of the substrate 1 and may be changed as appropriate. In the case where the adhesive layer 71 is composed of PTFE, a relative dielectric constant E_{G} of the adhesive layer 71 is about 2.5 and a Young's modulus E_{G} of the adhesive layer 71 is about 0.1 GPa.

In this preferred embodiment, the relative dielectric constant ε_{G} of the adhesive layer 71 is lower than the relative dielectric constant ε_{P} of the protective layer 2 (ε_{G}<ε_{P}). In the case where a surface mounted member such as the routing member 101 has conductivity, a parasitic capacitance will be generated between the surface mounted member and the coil conductor 10. This parasitic capacitance varies with variations in a thickness D1 of the adhesive layer 71 positioned between the routing member 101 and the coil conductor 10 and the thickness D1 of the adhesive layer 71 positioned between the routing member 101 and the coil conductor 10 is likely to vary at the time of adhesion (hardening). Accordingly, it is preferable that the adhesive layer 71, which is positioned between the routing member 101 and the coil conductor 10, be composed of a material that has a lower dielectric constant than members (protective layer 2 and so on), other than the adhesive layer 71, that are positioned between the routing member 101 and the coil conductor 10. Due to this configuration, changes in characteristics that occur with changes (variations) in the thickness D1 of the adhesive member 71 positioned between the routing member 101 and the coil conductor 10 are significantly reduced or prevented.

In addition, in this preferred embodiment, the Young's modulus E_{G} of the adhesive layer 71 is lower than the Young's modulus E_{B} of the substrate 1 and the Young's modulus E_{P} of the protective layer 2 (E_{G}<E_{P}) (E_{G}<E_{B}). By positioning a material having a low Young's modulus between the substrate 1 and the protective layer 2, damaging of the antenna device 101 caused by the antenna device 101 being pressing when the antenna device 101 is being fixed in place or by impacts from the outside is significantly reduced or prevented. However, in the case where the Young's modulus E_{G} of the adhesive layer 71 is lower than the Young's modulus of the substrate 1 and the Young's modulus E_{P} of the protective layer 2, as in this preferred embodiment, the thickness is likely to vary after the adhesive layer 71 hardens as well. Therefore, in order to significantly reduce or prevent changes in characteristics that occur with variations in the thickness D1 of the adhesive layer 71, it is particularly preferable that the adhesive layer 71 positioned between the routing member 101 and the coil conductor 10 be composed of a material that has a lower dielectric constant than other members positioned between the routing member 101 and the coil conductor 10.

The routing member 21 is a rectangular or substantially rectangular flat metal plate and connects an inner peripheral portion and an outer peripheral portion of the coil conductor 10 to each other. The routing member 21 includes, at the two end portions thereof in the longitudinal direction thereof, a first connection portion 31 and a second connection portion 32 that are electrically connected to each other. The first connection portion 31 is a portion that faces the first connection terminal 11 and the second connection portion 32 is a portion that faces the second connection terminal 12. Therefore, in the antenna device 101 according to this preferred embodiment, the routing member 21 is disposed close to one corner (top right corner in FIG. 1) of the antenna device 101.

The routing member 21 is, for example, a flat metal plate obtained by forming Ni plating layers 42 and 43 on both main surfaces of a stainless steel (SUS301, SUS304 etc.) substrate 41 and forming a Sn—Ag—Cu plating layer 44 on a mounting surface (lower surface in FIG. 3B) side. Consequently, the first connection portion 31 is connected to the first connection terminal 11 provided at an end of the inner peripheral portion of the coil conductor 10 via a conductive joining material 61 and the second connection portion 32 is connected to the second connection terminal 12 provided at an end of the outer peripheral portion of the coil conductor 10 via a conductive joining material 62. In other words, the inner peripheral portion and the outer peripheral portion (first connection terminal 11 and second connection terminal 12) of the coil conductor 10 are connected to each other via the routing member 21. The conductive joining materials 61 and 62 are, for example, Sn-based solder, an anisotropic conductive paste (ACF) or an anisotropic conductive film (ACF). The routing member 21 may be composed of another material and can be used without being plated if composed of phosphor bronze or brass.

Furthermore, as illustrated in FIG. 3B, in the antenna device 101 according to this preferred embodiment, the routing member 21 extends over (spans across) the coil conductor 10, which is located between the first connection terminal 11 and the second connection terminal 12. In other words, the routing member 21 is arranged so as to bridge between the inner peripheral portion and the outer peripheral portion of the coil conductor 10 and so that at least a portion thereof between the first connection portion 31 and the second connection portion 32 faces the coil conductor 10.

The first external connection terminal plate 3 and the second external connection terminal plate 4 are flat plates having a square or substantially square planar shape and are terminals that connect to an external circuit such as an RFIC element. The first external connection terminal plate 3 and the second external connection terminal plate 4 are respectively superposed in plan view with the first external connection terminal 13 and the second external connection terminal 14 and are respectively electrically connected to the first external connection terminal 13 and the second external connection terminal 14. The first external connection terminal plate 3 and the second external connection terminal plate 4 are, for example, each composed of Cu foil, the surface of which is plated with Au or the like. In the antenna device 101, a configuration is adopted in which the first external connection terminal plate 3 and the second external connection terminal plate 4 are buried in one main surface (upper main surface in FIG. 2) of the antenna device 101 and are exposed through the protective layer 2, as illustrated in FIG. 1, FIG. 2, etc. The first external connection terminal plate 3 and the second external connection terminal plate 4 may be formed of another material such as stainless steel (SUS 301, SUS304, etc.), phosphor bronze, a nickel alloy or the like.

According to this preferred embodiment, the following effects are obtained.

In this preferred embodiment, the routing member 21, which connects the inner peripheral portion and the outer peripheral portion of the coil conductor 10 to each other, is mounted (disposed) using the conductive joining materials 61 and 62 and therefore is able to be surface mounted in the same way as a typical surface mount device such as an RFIC element. Consequently, there is no need for a process such as pressing the routing member 21 against the coil conductor 10 and welding the routing member 21 to the coil conductor 10. Therefore, an antenna device is provided in which the inner peripheral portion and the outer peripheral portion of the spiral-shaped coil conductor 10, which is provided on a main surface of the substrate 1, are able to be connected to each other using a simple structure and process.

In addition, in the case where the first external connection terminal plate 3 and the second external connection terminal plate 4 are to be mounted (disposed) using conductive joining materials, a manufacturing device that mounts (disposes) the first external connection terminal plate 3 and the second external connection terminal plate 4 using conductive joining materials (mounting device for surface mount devices) is able to be used and therefore the manufacturing process is simple and a cost reduction is achieved.

In the antenna device 101 according to this preferred embodiment, the routing member 21 includes a flat metal plate and therefore there is no need to form a separate conductor to the routing member 21 and the manufacturing process is simple and a cost reduction is achieved. In addition, since the entire routing member 21 has conductivity, a resistance component is reduced and conductor loss in the routing member 21 is significantly reduced or prevented and an antenna device having a high Q value (low loss) is obtained.

The antenna device 101 according to this preferred embodiment is manufactured using the following processes, for example.

First, the substrate 1 to which a metal foil is affixed is prepared. More precisely, a metal foil is disposed on (affixed to) substantially the entirety of one main surface of the substrate 1. As described above, the metal foil is a Cu foil, for example.

Next, the metal foil affixed to the one main surface of the substrate 1 is patterned by performing etching or the like in order to form the coil conductor 10, the first connection terminal 11, the second connection terminal 12, the first external connection terminal 13 and the second external connection terminal 14.

Next, the adhesive layer 71 is provided on the one main surface of the substrate 1. Specifically, the adhesive layer 71 is provided on the substrate 1 by screen printing or the like. Next, the protective layer 2, which is formed in the same or substantially the same shape as the substrate 1, is affixed to the one main surface of the substrate 1. The adhesive layer 71 is formed by screen printing or the like on one main surface of the protective layer 2, and then, the one main surface of the substrate 1 may be affixed to the main surface of the protective layer 2 on which the adhesive layer 71 is formed.

Next, the routing member 21 is die cut from the flat metal plate by performing press working, laser processing, etching or the like. At this time, the surface of the routing member 21 is subjected to plating processing, as needed.

Next, the first connection portion 31 of the routing member 21 is connected to the first connection terminal 11 provided at an end of the inner peripheral portion of the coil conductor 10 via the conductive joining material 61 and the second connection portion 32 is connected to the second connection terminal 12 provided at an end of the outer peripheral portion of the coil conductor 10 via the conductive joining material 62. Furthermore, the first external connection terminal plate 3 and the second external connection terminal plate 4 are mounted so as to be respectively superposed in plan view with the first external connection terminal 13 and the second external connection terminal 14.

With this manufacturing method, it is possible to easily manufacture the antenna device 101 in which the inner peripheral portion and the outer peripheral portion of the spiral-shaped coil conductor 10, which is provided on a main surface of the substrate 1, are able to be connected to each other using a simple structure and process.

### Second Preferred Embodiment

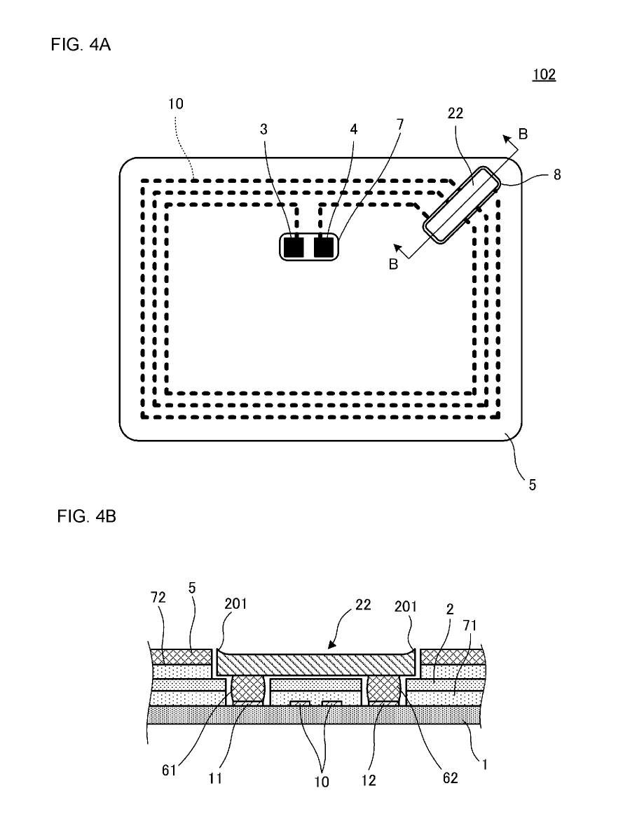

FIG. 4A is a plan view of an antenna device 102 according to a second preferred embodiment of the present invention and FIG. 4B is a sectional view taken along B-B in FIG. 4A. FIG. 4A and FIG. 4B illustrate the structure of a routing member 22 in a simplified manner in order to enable easy understand of the drawings and principles.

The antenna device 102 according to the second preferred embodiment differs from the antenna device 101 according to the first preferred embodiment in that the antenna device 102 further includes a magnetic material layer 5 and an adhesive layer 72. In addition, the shape of the routing member 22 is different. The rest of the configuration is the same as that of the antenna device 101 according to the first preferred embodiment.

Hereafter, the portions that are different from the antenna device 101 according to the first preferred embodiment will be described.

The magnetic material layer 5 is a rectangular or substantially rectangular flat plate and the planar shape thereof is the same or substantially the same as that of the protective layer 2. In this preferred embodiment, a hole 7 through which the first external connection terminal plate 3 and the second external connection terminal plate 4 are exposed and a hole 8 through which the routing member 22 is exposed are provided in the magnetic material layer 5. The magnetic material layer 5 is affixed to one main surface (upper surface in FIG. 4B) of the protective layer 2 via the adhesive layer 72. The magnetic material layer 5 is, for example, a ceramic layer such as a magnetic ferrite ceramic layer or a ferrite-powder-containing resin layer obtained by dispersing a magnetic ferrite powder inside a resin. The planar shape of the magnetic material layer 5 is not limited to being the same or substantially the same shape as the protective layer 2 and may be changed as appropriate.

The adhesive layer 71 is thin in order to make the magnetic material layer 5 and the coil conductor 10 be close to each other. The thickness of the adhesive layer 71 between the routing member 102 and the coil conductor 10 is about 5 μm to about 10 μm, for example, but is likely to vary at the time of adhesion (hardening). Generally, when the thickness varies in a thinly formed portion, the percentage of the variation of the thickness is large and the range of variation of a parasitic capacitance generated between a surface mounted member (routing member 102 etc.) and the coil conductor 10 is also large. Therefore, in order to make the range of variation (variations) of the parasitic capacitance generated between the routing member 102 and the coil conductor 10 small, it is preferable that the adhesive layer 71, which is positioned between the routing member 102 and the coil conductor 10, be composed of a material that has a lower dielectric constant than members (protective layer 2 and so on), other than the adhesive layer 71, that are positioned between the routing member 102 and the coil conductor 10.

The adhesive layer 72 has an insulating property and adhesiveness and is provided over substantially the entirety of the surface of the protective layer 2. The adhesive layer 72 is a double-sided adhesive sheet or a layer composed of an adhesive agent, for example. The adhesive layer 72 is not limited to being provided over substantially the entire surface of the protective layer 2 and may be changed as appropriate.

The routing member 22 of the antenna device 102 is a rectangular or substantially rectangular flat metal plate similarly to the routing member 21 according to the first preferred embodiment. The routing member 22 includes a protrusion 201 on one main surface thereof (upper surface in FIG. 4B). The protrusion 201 is a burr that is provided at an edge of the flat metal plate when the routing member 22 is die cut from the flat metal plate by press working or laser processing, for example.

In the antenna device 102, the routing member 21 is disposed such that the surface thereof (lower surface in FIG. 4B), which is on the opposite side to the surface thereof on which the protrusion 201 is provided at the time of processing (upper surface in FIG. 4B), faces the coil conductor 10.

The configuration of the antenna device 102 is the same or substantially the same as that of the antenna device 101 according to the first preferred embodiment and similar actions/effects to those of the antenna device 101 are exhibited with this configuration as well.

Furthermore, in the antenna device 102, since the surface of the routing member 22, which is on the opposite side to the surface of the routing member 22 on which the protrusion 201 is provided at the time of processing, faces the coil conductor 10, the protrusion 201 of the routing member 22 is able to be prevented from contacting the coil conductor 10. Therefore, the occurrence of a problem such as breaking, severing or short circuiting of the coil conductor 10 caused by the protrusion 201 contacting the coil conductor 10 is significantly reduced or prevented.

In addition, the antenna device 102 further includes the magnetic material layer 5. Consequently, a prescribed inductance is obtained due to the action of the high magnetic permeability of the magnetic material layer 5 and the conductor pattern having a small number of turns. Furthermore, magnetic field coupling with the antenna of a communication partner is able to be increased by the magnetism collecting effect of the magnetic material layer 5. In addition, with this configuration that includes the magnetic material layer 5, a rear-surface-side magnetism shielding effect is also obtained.

In this preferred embodiment, although an example configuration is described in which the protective layer 2 is disposed between the coil conductor 10 and the magnetic material layer 5, the magnetic material layer 5 may instead be arranged between the protective layer 2 and the coil conductor 10. Furthermore, the coil conductor 10 may be arranged between the protective layer 2 and the magnetic material layer 5. That is, the arrangement relationship between the magnetic material layer 5 and the coil conductor 10 may be changed as appropriate. However, in the case where the antenna device 102 is housed in a casing, it is preferable that the magnetic material layer 5 be disposed on the side of the coil conductor 10 which is opposite the side of the coil conductor 10 where the casing is disposed. With this configuration, since the coil conductor 10 is disposed so as to be closer to the antenna of the communication partner than the magnetic material layer 5, the coupling between the antenna device 102 and the antenna of the communication partner is increased and the communication characteristics are improved. In addition, with this configuration, a rear-surface-side magnetism shielding effect is obtained due to the magnetic material layer 5 and unwanted coupling between other components disposed inside the casing and the antenna device 102 is significantly reduced or prevented.

### Third Preferred Embodiment

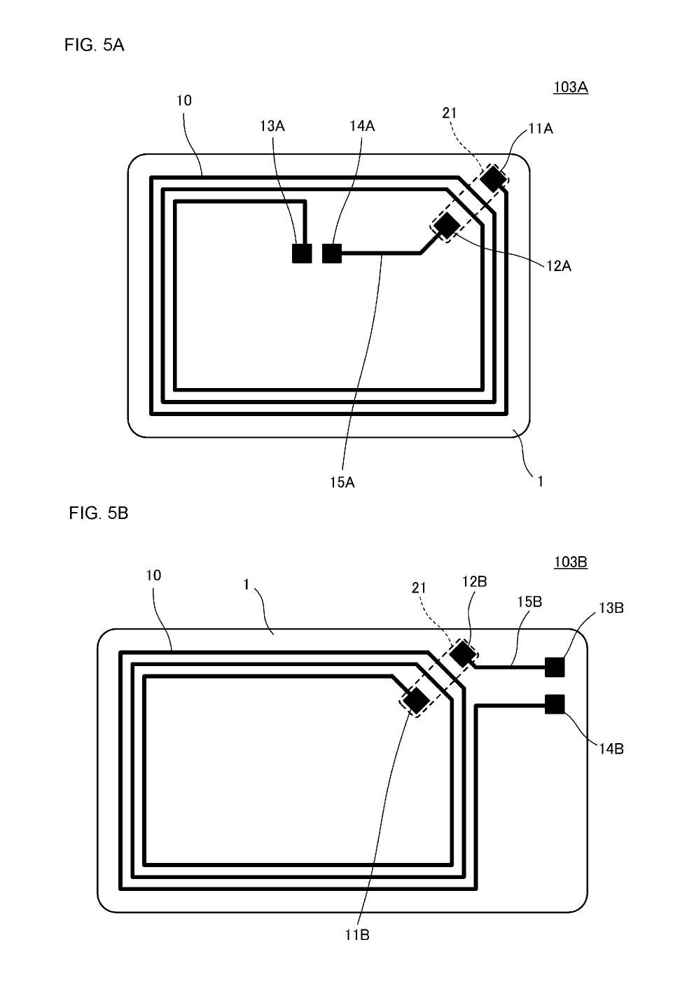

In a third preferred embodiment of the present invention, two antenna devices having different structures will be described. FIG. 5A is a plan view of an antenna device 103A and FIG. 5B is a plan view of an antenna device 103B according to the third preferred embodiment. In FIG. 5A and FIG. 5B, in order to make the structures easier to understand, illustration of a protective layer, an adhesive layer, a first external connection terminal plate, a second external connection terminal plate and a routing member is omitted.

The antenna devices 103A and 103B according to the third preferred embodiment mainly differ from the antenna device 101 according to the first preferred embodiment in terms of the planar shape of the coil conductor 10 provided on the one main surface of the substrate 1. The rest of the configurations are substantially the same as that of the antenna device 101 according to the first preferred embodiment. Hereafter, the portions that are different from the antenna device 101 according to the first preferred embodiment will be described.

The antenna device 103A illustrated in FIG. 5A further includes a connection conductor 15A. In this preferred embodiment, a first connection terminal 11A is a conductor pattern that is provided at the outer peripheral end of the coil conductor 10 and a second connection terminal 12B is a conductor pattern that is provided at the inner peripheral end of the coil conductor 10.

The connection conductor 15A is not a conductor pattern that constitutes part of the coil conductor 10 but, rather, is a conductor pattern that connects the second connection terminal 12A and the second external connection terminal 14, which are positioned inside the coil conductor 10, to each other. In other words, as illustrated in FIG. 5A, the first connection terminal 11A is an outer peripheral portion of the coil conductor 10, but the second connection terminal 12A is not the inner peripheral portion of the coil conductor 10. Therefore, the first connection portion of the routing member 21 is connected to the outer peripheral portion (first connection terminal 11A) of the coil conductor 10 via a conductive joining material.

The configuration of the antenna device 103A is the same or substantially the same as that of the antenna device 101 according to the first preferred embodiment and similar actions/effects to those of the antenna device 101 are exhibited with this configuration as well.

The antenna device 103B illustrated in FIG. 5B further includes a connection conductor 15B and the arrangements of a first external connection terminal 13B and a second external connection terminal 14B are different. The first external connection terminal 13B and the second external connection terminal 14B of the antenna device 103B are arranged outside the coil conductor 10. In addition, in this preferred embodiment, a first connection terminal 11B is a conductor pattern that is provided at the inner peripheral end of the coil conductor 10 and a second connection terminal 12B is a conductor pattern that is provided at the outer peripheral end of the coil conductor 10.

The connection conductor 15B is not a conductor pattern that constitutes part of the coil conductor 10 but, rather, is a conductor pattern that connects the second connection terminal 12B and the first external connection terminal 13B, which are positioned outside the coil conductor 10, to each other. That is, as illustrated in FIG. 5B, although the first connection terminal 11B is the inner peripheral portion of the coil conductor 10, the second connection terminal 12B is not the outer peripheral portion of the coil conductor 10. Therefore, the first connection portion of the routing member 21 is connected to the inner peripheral portion (first connection terminal 11B) of the coil conductor 10 via a conductive joining material.

The configuration of the antenna device 103B is the same or substantially the same that of the antenna device 101 according to the first preferred embodiment and similar actions/effects to those of the antenna device 101 are exhibited with this configuration as well.

Furthermore, as described in the antenna devices 103A and 103B according to this preferred embodiment, an antenna device of the present invention is not limited to a configuration in which the first connection terminal is connected to the inner peripheral portion of the coil conductor 10 and the second connection terminal is connected to an outer peripheral portion of the coil conductor 10. It is sufficient that a configuration be adopted in which the first connection portion of the routing member 21 is connected to the inner peripheral portion or the outer peripheral portion of the coil conductor 10.

### Fourth Preferred Embodiment

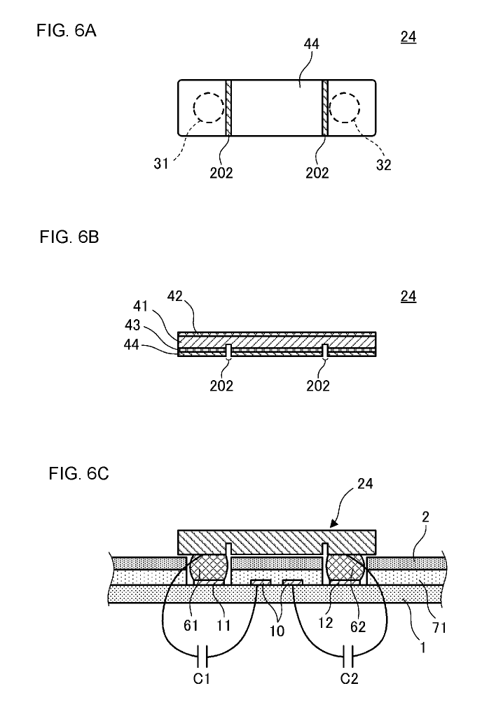

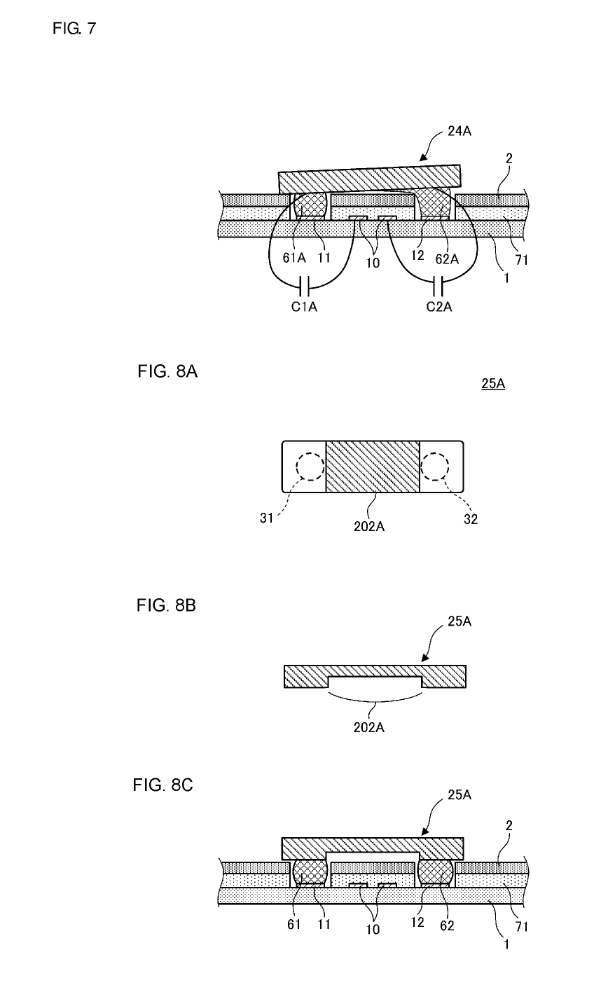

FIG. 6A is a rear surface view of a routing member 24 according to fourth preferred embodiment of the present invention, FIG. 6B is a sectional view of the routing member 24 and FIG. 6C is a sectional view of a mounting portion of the routing member 24. FIG. 7 is a sectional view of a comparative example and illustrates a mounting portion of a routing member 24A in which grooves are not formed. FIG. 6C and FIG. 7 illustrate the structures of the routing members in a simplified manner in order to enable easy understand of the drawings and principles.

The routing member 24 differs from the routing member 21 according to the first preferred embodiment in that grooves 202 are provided on a mounting surface (lower surface in FIG. 6B and FIG. 6C) side thereof. The rest of the configuration is the same or substantially the same as that of the antenna device 101 according to the first preferred embodiment. Hereafter, the portions that are different from the antenna device 101 according to the first preferred embodiment will be described.

Two grooves 202 are provided between the first connection portion 31 and the second connection portion 32 in the mounting surface of the routing member 24 according to the fourth preferred embodiment. The grooves 202 are provided close to the first connection portion 31 and the second connection portion 32 and extend in a lateral direction of the routing member 24. The two ends of each groove 202 reach the edges of the routing member 24 in the lateral direction of the routing member 24 (upper edge and lower edge in FIG. 6B).

In this preferred embodiment, the grooves 202 are provided between the first connection portion 31 and the second connection portion 32 and therefore spreading of the conductive joining materials 61 and 62 into the region between the first connection portion 31 and the second connection portion 32 is significantly reduced or prevented. Therefore, a decrease in the amount of the conductive joining material 61 that is between the first connection portion 31 and the coil conductor 10 and a decrease in the amount of the conductive joining material 62 that is between the second connection portion 32 and the coil conductor 10 can be prevented. Therefore, it is possible to maintain the strength of the joint between the first connection portion 31 and the first connection terminal 11 and the strength of the joint between the second connection portion 32 and the second connection terminal 12 as high.

As illustrated in FIG. 7, in the case where the routing member 24A, in which grooves are not formed, is mounted on the substrate 1, there is a possibility that, for example, a conductive joining material 62A will spread into the region between the first connection portion and the second connection portion and that as a consequence the mounting surface of the routing member 24A will not be parallel or substantially parallel to the main surface of the substrate 1. Therefore, parasitic capacitances C1A and C2A generated between the conductor of the routing member 24A and the coil conductor 10 will be unstable and variations will be generated in the impedance of the antenna device.

Thus, in this preferred embodiment, the conductive joining materials 62A and 62A do not spread into the region between the first connection portion 31 and the second connection portion 32 and therefore the mounting surface of the routing member 24 is parallel or substantially parallel to the main surface of the substrate 1. Therefore, the stability of the parasitic capacitances C1 and C2 generated between the routing member 24 and the coil conductor 10 is improved and variations in the impedance of the antenna device are significantly reduced or prevented.

In the antenna device according to this preferred embodiment, a configuration is adopted in which two grooves 202 are provided close to the first connection portion 31 and the second connection portion 32 and in which the grooves 202 extend in the lateral direction of the routing member 24. Therefore, spreading of the conductive joining materials is more effectively prevented than in the case of a configuration in which a groove 202 is provided in the center between the first connection portion 31 and the second connection portion 32.

In addition, since the two ends of each of the grooves 202 reach the edges of the routing member 24, spreading of the conductive joining materials from the ends of the grooves 202 is able to be prevented.

In this preferred embodiment, as illustrated in FIG. 6B and 6C, the grooves 202 that preferably have a rectangular or substantially rectangular shape when viewed from the side surface of the routing member 24 are provided, but not limited to this configuration, the sectional shape of the grooves 202 may be changed as appropriate. For example, a V shape or a U shape may be considered as the sectional shape of the grooves. In addition, in this preferred embodiment, a configuration is adopted in which the grooves 202 reach the substrate 41 but the grooves 202 are not limited to this configuration. The depth of the grooves 202 may be changed as appropriate.

### Fifth Preferred Embodiment

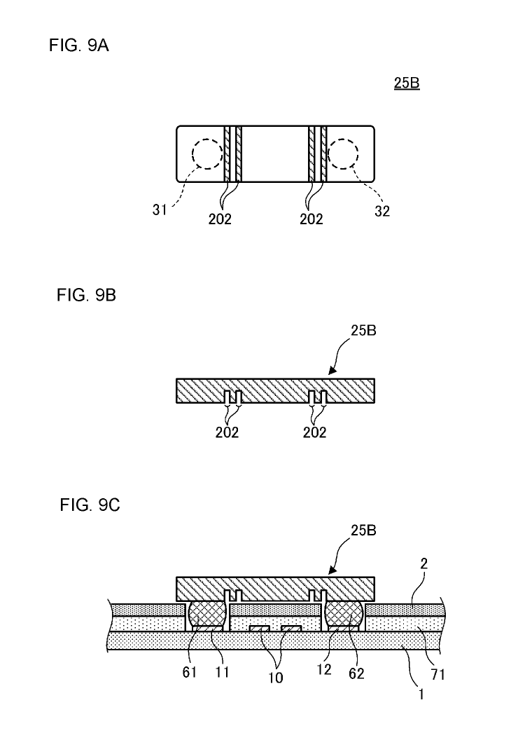

In a fifth preferred embodiment of the present invention, modifications of the antenna device according to the fourth preferred embodiment are described. FIG. 8A is a rear surface view of a routing member 25A according to the fifth preferred embodiment, FIG. 8B is a sectional view of the routing member 25A and FIG. 8C is a sectional view of a mounting portion of the routing member 25A. FIG. 9A is a rear surface view of a routing member 25B according to the fifth preferred embodiment, FIG. 9B is a sectional view of the routing member 25B and FIG. 9C is a sectional view of a mounting portion of the routing member 25B. FIGS. 8B and 8C and FIGS. 9B and 9C illustrate the structures of the routing members in a simplified manner in order to enable easy understand of the drawings and principles.

The configurations of grooves of the antenna devices according to the fifth preferred embodiment differ from that of the grooves of the antenna device according to the fourth preferred embodiment. The rest of the configurations are substantially the same as that of the antenna device 104 according to the fourth preferred embodiment. Hereafter, the portions that are different from the antenna device according to the fourth preferred embodiment will be described.

A mounting surface of the routing member 25A illustrated in FIG. 8A includes one groove 202A between the first connection portion 31 and the second connection portion 32. The groove 202A extends across the entire surface of the routing member 25A between the first connection portion 31 and the second connection portion 32. Therefore, the groove 202A is close to the first connection portion 31 and the second connection portion 32 and is formed so as to extend in a lateral direction of the routing member 25A. Furthermore, the two ends of the groove 202A reach the edges of the routing member 25A in the lateral direction of the routing member 25A (upper edge and lower edge in FIG. 8A).

The configuration of the routing member 25A is the same or substantially the same as that of the routing member 24 according to the fourth preferred embodiment and similar actions/effects to those of the antenna device according to the fourth preferred embodiment are exhibited with this configuration as well. In addition, as illustrated in this preferred embodiment, the shape, size and so forth of the groove(s) may be changed as appropriate within the range in which the above-described actions/effects are exhibited.

Four grooves 202 are provided, for example, between the first connection portion 31 and the second connection portion 32, in a mounting surface of the routing member 25B illustrated in FIG.

9B. The grooves 202 are provided close to the first connection portion 31 and the second connection portion 32 and extend in a lateral direction of the routing member 25B. The two ends of each groove 202 reach the edges of the routing member 25B in the lateral direction of the routing member 25B (upper edge and lower edge in FIG. 9A). In other words, the routing member 25B is obtained by forming an additional two grooves between the two grooves 202 of the routing member 24 according to the fourth preferred embodiment.

The configuration of the routing member 25B is the same or substantially the same as that of the routing member 24 according to the fourth preferred embodiment and similar actions/effects to those of the antenna device according to the fourth preferred embodiment are exhibited with this configuration as well.

In addition, as illustrated in this preferred embodiment, the number of grooves, etc., may be changed as appropriate within the range in which the above-described actions/effects are exhibited. Therefore, an antenna device of the present invention can also be structured such that a plurality of grooves are provided between the first connection portion 31 and the second connection portion 32.

### Sixth Preferred Embodiment

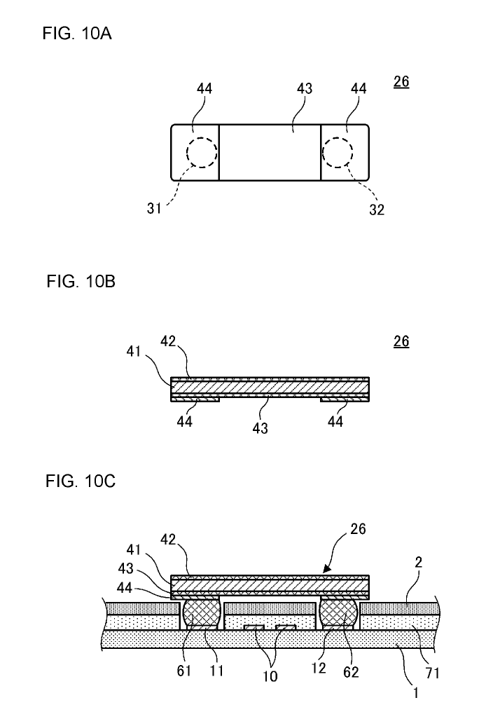

FIG. 10A is a rear surface view of a routing member 26 according to a sixth preferred embodiment of the present invention, FIG. 10B is a sectional view of the routing member 26 and FIG. 10C is a sectional view of a mounting portion of the routing member 26.

In the sixth preferred embodiment, the structure of the routing member 26 is different from that of the routing member 21 according to the first preferred embodiment. The rest of the configuration is the same or substantially the same as that of the antenna device 101 according to the first preferred embodiment. Hereafter, the portions that are different from the antenna device 101 according to the first preferred embodiment will be described.

In the routing member 26, Sn—Ag—Cu plating layers 44 are provided on the first connection portion 31 and the second connection portion 32 of the mounting surface (lower surface in FIG. 10B and FIG. 10C) and a Ni plating layer 43 is provided over the entirety of the surface between the first connection portion 31 and the second connection portion 32. The Sn—Ag—Cu plating layers 44 have higher wettability to Sn-based solder, which forms the conductive joining material, than the Ni plating layer 43. Therefore, in this preferred embodiment, the first connection portion 31 and the second connection portion 32 have relatively high wettability to the conductive joining materials compared to the region between the first connection portion 31 and the second connection portion 32.

In this preferred embodiment, since the first connection portion 31 and the second connection portion 32 have relatively high wettability to the conductive joining materials, spreading of the conductive joining materials 61 and 62 into the region between the first connection portion 31 and the second connection portion 32 is significantly reduced or prevented. Therefore, a decrease in the amount of the conductive joining material 61 that is between the first connection portion 31 and the coil conductor 10 and a decrease in the amount of the conductive joining material 62 that is between the second connection portion 32 and the coil conductor is prevented. Therefore, it is possible to maintain the strength of the joint between the first connection portion 31 and the first connection terminal 11 and the strength of the joint between the second connection portion 32 and the second connection terminal 12 as high.

Thus, in this preferred embodiment, the conductive joining materials 61 and 62 do not spread into the region between the first connection portion 31 and the second connection portion 32 and therefore the mounting surface of the routing member 26 is parallel or substantially parallel to the main surface of the substrate 1. Therefore, the stability of the parasitic capacitances C1 and C2 generated between the routing member 26 and the coil conductor 10 is improved and variations in the impedance of the antenna device are reduced.

Furthermore, in this preferred embodiment, the first connection portion 31 and the second connection portion 32, which have relatively high wettability to the conductive joining materials compared to the region between the first connection portion 31 and the second connection portion, are easily formed.

### Seventh Preferred Embodiment

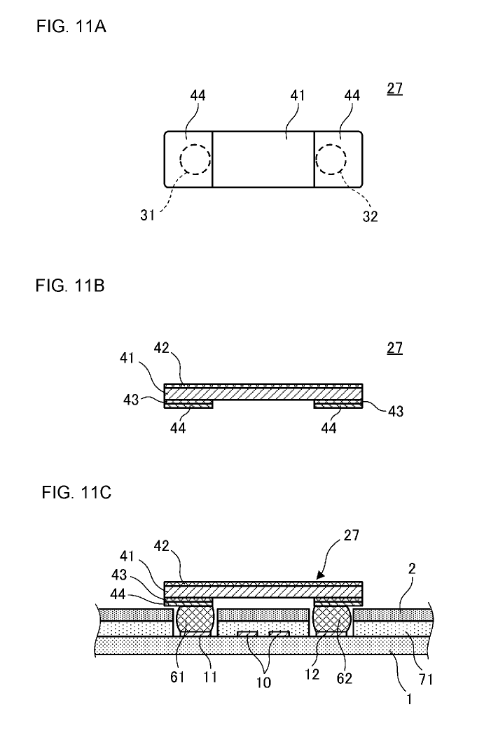

In a seventh preferred embodiment of the present invention, a modification of the antenna device according to the sixth preferred embodiment is described. FIG. 11A is a rear surface view of a routing member 27 according to a seventh preferred embodiment, FIG. 11B is a sectional view of the routing member 27 and FIG. 11C is a sectional view of a mounting portion of the routing member 27.

In the seventh preferred embodiment, the structure of the routing member 27 is different from that of the routing member 21 according to the sixth preferred embodiment. The rest of the configuration is the same or substantially the same as that of the antenna device according to the sixth preferred embodiment. Hereafter, the portions that are different from the antenna device according to the sixth preferred embodiment will be described.

Ni plating layers 43 and Sn—Ag—Cu plating layers 44 are provided on the first connection portion 31 and the second connection portion 32 of the mounting surface (lower surface in FIG. 11B and FIG. 11C) of the routing member 27. No plating film is provided on the entirety of the surface of the region between the first connection portion 31 and the second connection portion 32 and therefore the substrate 41 is exposed in this region. The Sn—Ag—Cu plating layers 44 and the Ni plating layers 43 have higher wettability to Sn-based solder, which forms the conductive joining materials, compared with the substrate 41. Therefore, in this preferred embodiment, the first connection portion 31 and the second connection portion 32 have relatively high wettability to the conductive joining materials compared to the region between the first connection portion 31 and the second connection portion 32.

Thus, the type, number, shape, size and extent of plating films provided on the routing member may be changed as appropriate within the range in which the action/effect of the wettability of the first connection portion 31 and the second connection portion 32 to the conductive joining materials being relatively higher than that in the region between the first connection portion 31 and the second connection portion 32 is exhibited.

### Eighth Preferred Embodiment

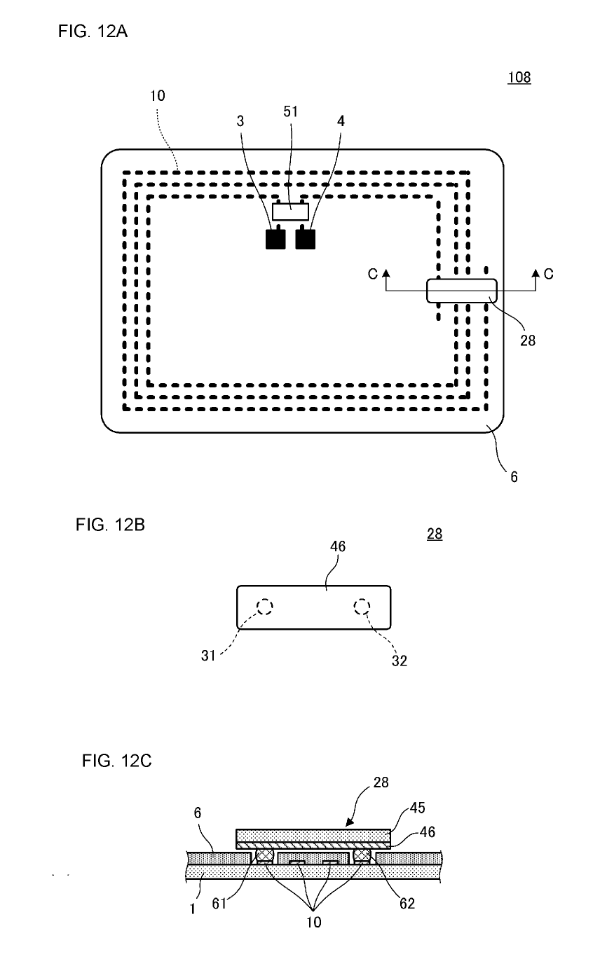

FIG. 12A is a plan view of an antenna device 108 according to an eighth preferred embodiment of the present invention and FIG. 12B is a rear surface view of a routing member 28 according to the eighth preferred embodiment. FIG. 12C is a sectional view taken along C-C in FIG. 12A.

The antenna device 108 according to the eighth preferred embodiment differs from the antenna device 101 according to the first preferred embodiment in that the antenna device 108 further includes an insulating layer 6 and a surface mount device 51. In addition, the structures of the coil conductor 10 and the routing member 28 are different. The rest of the configuration is the same as that of the antenna device 101 according to the first preferred embodiment. Hereafter, the portions that are different from the antenna device 101 according to the first preferred embodiment will be described.

The insulating layer 6 is a rectangular or substantially rectangular flat plate and has the same or substantially the same planar shape as the substrate 1. The insulating layer 6 is provided on one main surface of the substrate 1 (upper surface in FIG. 12B). The insulating layer 6 is a layer such as a solder resist film or an oxide film. The planar shape of the insulating layer 6 is not limited to being the same or substantially the same as that of the substrate 1 and may be changed as appropriate.

The routing member 28 according to this preferred embodiment is disposed near the center of one edge of the antenna device 108 (right edge in FIG. 12A). The routing member 28 includes a substrate layer 45 that is composed of an insulating material such as a resin. A conductor layer 46 is provided on a surface of the routing member 28 that faces the coil conductor 10 (lower surface in FIG. 12C). The substrate layer 45 is a resin sheet composed of polyimide or a liquid crystal polymer (LCP), for example. The conductor layer 46 is a thin metal plate and is a Cu foil, for example. The substrate layer 45 of the routing member 28 is composed of the same material as the substrate 1.

The surface mount device 51 is mounted on a main surface of the protective layer 2 and is connected to the coil conductor 10 via conductive joining materials, which are not illustrated. The surface mount device 51 is a chip capacitor of a resonance circuit of the antenna device 108, for example.

The coil conductor 10 according to this preferred embodiment does not have a first connection terminal and a second connection terminal. Furthermore, as illustrated in FIG. 12A, the portions of the coil conductor 10 that are connected to the first connection portion and the second connection portion of the routing member 28 via the conductive joining materials 61 and 62 are not the ends of the inner peripheral portion and the outer peripheral portion of the coil conductor 10.

The configuration of the antenna device 108 is the same or substantially the same as that of the antenna device 101 according to the first preferred embodiment and similar actions/effects to those of the antenna device 101 according to the first preferred embodiment are exhibited with this configuration as well.

If the coefficient of linear expansion of the routing member and the coefficient of linear expansion of the substrate are different to each other, the routing member will warp when the conductive joining materials are heated. However, this can be prevented in the antenna device according to this preferred embodiment. Therefore, contact defects and shorts between the first connection portion and the coil conductor and between the second connection portion and the coil conductor is significantly reduced or prevented and the yield when manufacturing the antenna device is able to be increased. In the antenna device 108 according to this preferred embodiment, an example is described in which the substrate layer 45 is formed of the same material as the substrate 1 but the substrate layer 45 is not limited to this. It is sufficient that the substrate layer 45 be formed of a material that has a similar coefficient of linear expansion to the substrate 1.

In addition, in the case where the surface mount device 51 is mounted (disposed) using a conductive joining material, a manufacturing device (mounting device for surface mount device 51) that mounts (disposes) the surface mount device 51 using a conductive joining material is able to be used to mount the routing member 28 and therefore the manufacturing process is simple and a cost reduction is achieved. In addition, if the same type of conductive joining agent as the conductive joining agent that mounts the routing member 28 is used as the conductive joining agent that mounts the surface mount device 51, manufacturing with an even simpler process is possible.

A protective layer is not an essential component, as illustrated in this preferred embodiment. Since there is no need to affix a protective layer to one main surface of the substrate 1 via an adhesive layer in the antenna device 108, the antenna device is able to be formed with a simple structure and process. Furthermore, by omitting the protective layer, an antenna device is provided that is flexible and thin.

In addition, as described in this preferred embodiment, the position of the routing member 28 is not limited to being close to one corner of the antenna device 108 and may be changed as appropriate. Furthermore, the portions of the coil conductor 10 that are connected to the first connection portion and the second connection portion of the routing member 28 via the conductive joining materials 61 and 62 are not limited to being the ends of the inner peripheral portion and the outer peripheral portion of the coil conductor 10.

### Ninth Preferred Embodiment

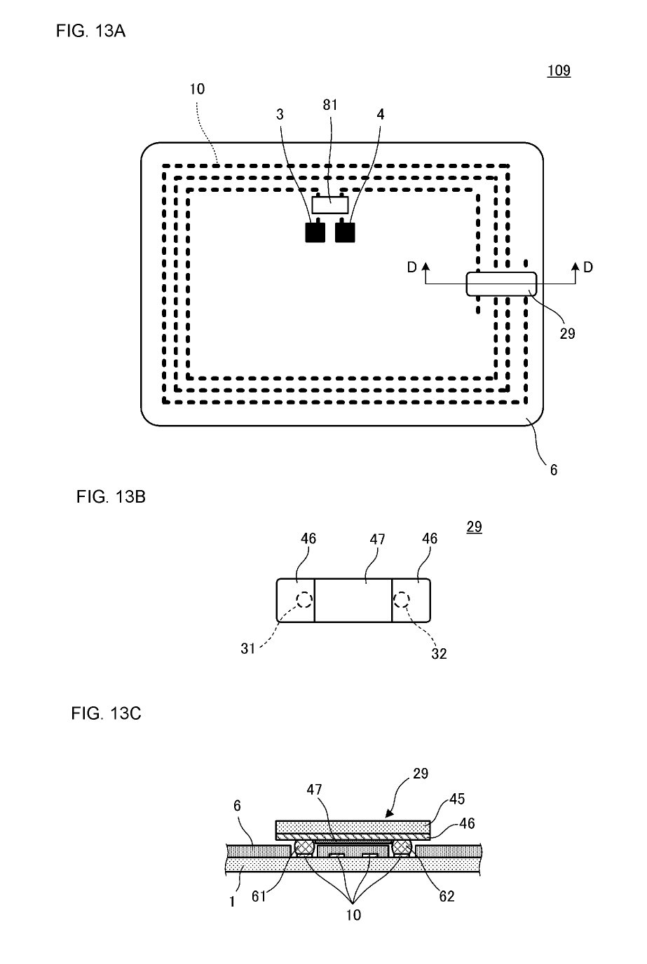

In a ninth preferred embodiment of the present invention, a modification of the antenna device according to the eighth preferred embodiment is described. FIG. 13A is a plan view of an antenna device 109 according to the ninth preferred embodiment, FIG. 13B is a rear surface view of a routing member 29 according to the ninth preferred embodiment and FIG. 13C is a sectional view of a mounting portion of the routing member 29.

In the ninth preferred embodiment, the structure of the routing member 29 is different from that of the routing member 28 according to the eighth preferred embodiment, but the rest of the configuration is the same or substantially the same as that of the antenna device 108 according to the eighth preferred embodiment. Hereafter, the portions that are different from the antenna device 108 according to the eighth preferred embodiment will be described.

An insulating layer 47 is provided over the entire surface of the region between the first connection portion 31 and the second connection portion 32 of the mounting surface of the routing member 29 (lower surface in FIG. 13C. The insulating layer 47 is located close to the first connection portion 31 and the second connection portion 32. In addition, the two end portions of the insulating layer 47 reach the edges of the routing member 29 in the lateral direction of the routing member 29 (upper edge and lower edge in FIG. 13B). The insulating layer 47 is a layer including a solder resist film or an oxide film, for example.

The insulating layer 47 has low wettability to Sn-based solder, which defines the conductive joining materials, compared to the conductor layer 46. Therefore, in this preferred embodiment, the first connection portion 31 and the second connection portion have relatively high wettability to the conductive joining materials 61 and 62 compared to the region between the first connection portion 31 and the second connection portion 32.

In this preferred embodiment, the insulating layer 47 is provided between the first connection portion 31 and the second connection portion 32 and therefore spreading of the conductive joining materials 61 and 62 into the region between the first connection portion 31 and the second connection portion 32 is significantly reduced or prevented. Therefore, a decrease in the amount of the conductive joining material 61 that is between the first connection portion 31 and the coil conductor 10 and a decrease in the amount of the conductive joining material 62 that is between the second connection portion 32 and the coil conductor is prevented. Therefore, it is possible to maintain the strength of the joint between the first connection portion 31 and the coil conductor 10 and the strength of the joint between the second connection portion 32 and the coil conductor 10 as high.

Thus, in this preferred embodiment, the conductive joining materials 61 and 62 do not spread into the region between the first connection portion 31 and the second connection portion 32 and therefore the mounting surface of the routing member 29 is parallel or substantially parallel to the main surface of the substrate 1. Therefore, the stability of parasitic capacitances generated between the routing member 29 and the coil conductor 10 is improved and variations in the impedance of the antenna device is reduced.

In the antenna device according to this preferred embodiment, the insulating layer 47 is located close to the first connection portion 31 and the second connection portion 32. Therefore, spreading of the conductive joining material is more effectively prevented than in the case of a configuration in which the insulating layer 47 is provided in the center between the first connection portion 31 and the second connection portion 32.

In addition, since the two ends of the insulating layer 47 reach the edges of the routing member 29, spreading of the conductive joining materials from the portion where the insulating layer 47 is not formed can be prevented.

As described in this preferred embodiment, the shape, number and extent of the insulating layer 47 is able to be changed as appropriate within the range in which the above-described action/effect is exhibited. Therefore, an antenna device according to a preferred embodiment of the present invention can also be structured such that a plurality of insulating layers 47 are provided between the first connection portion 31 and the second connection portion 32.

### Tenth Preferred Embodiment

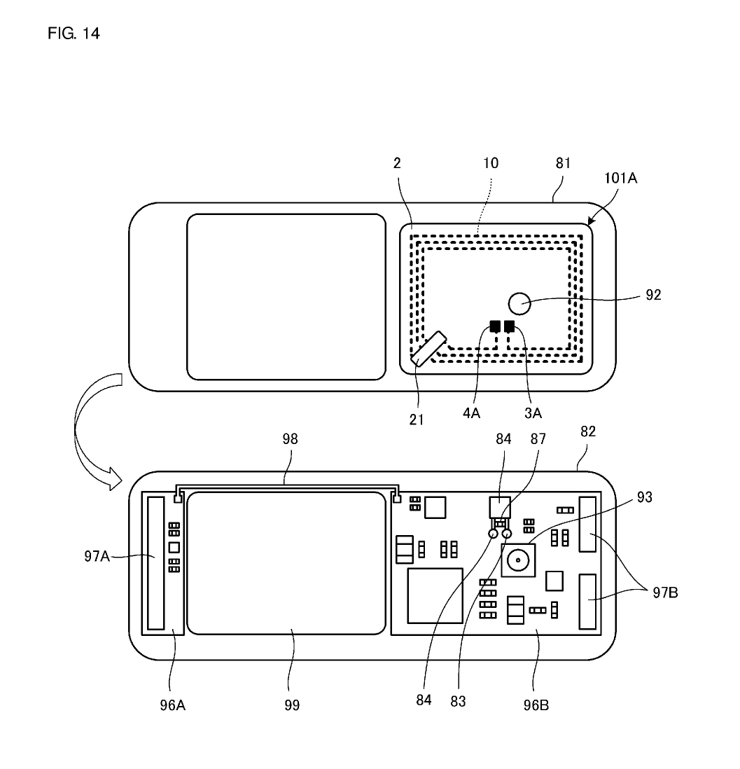

FIG. 14 is a plan view illustrating the structure inside a casing of an electronic appliance according to a tenth preferred embodiment of the present invention.

This electronic appliance is, for example, a cellular phone (including a smart phone), a wearable terminal (smart watch etc.), a laptop computer, a tablet terminal, a PDA, a camera, a games console or an RFID tag.

A camera module 93, circuit boards 96A and 96B, a battery pack 99 and so forth are accommodated inside an upper casing 82. A HF band antenna 97A and so forth are mounted on the circuit board 96A. In addition, HF band antennas 97B, a feeder circuit 85 including a communication circuit, a surface mount device 87 and feeder terminals 83 and 84, which are connected to the feeder circuit 85, are mounted on the circuit board 96B. The circuit board 96A and the circuit board 96B are connected to each other via a coaxial cable 98. The surface mount device 87 is a chip capacitor of a resonance circuit, for example.

An antenna device 101A is affixed to the inside of a lower casing 81. The antenna device 101A differs from the antenna device 101 according to the first preferred embodiment in that the antenna device 101A is provided with a camera hole 92. The antenna device 101A includes a first external connection terminal plate 3A and a second external connection terminal plate 4A. The first external connection terminal plate 3A and the second external connection terminal plate 4A respectively contact the feeder terminals 83 and 84 and are connected to the coil conductor 10.

Thus, even for an electronic appliance that does not have a wireless communication system, by arranging an antenna device according to a preferred embodiment of the present invention inside the electronic appliance, a communication terminal device that supports a HF band communication system or a power transmission system (described in detail later) is able to be provided. Therefore, it is possible for a communication terminal device and another external device to wirelessly communicate data.

### Eleventh Preferred Embodiment

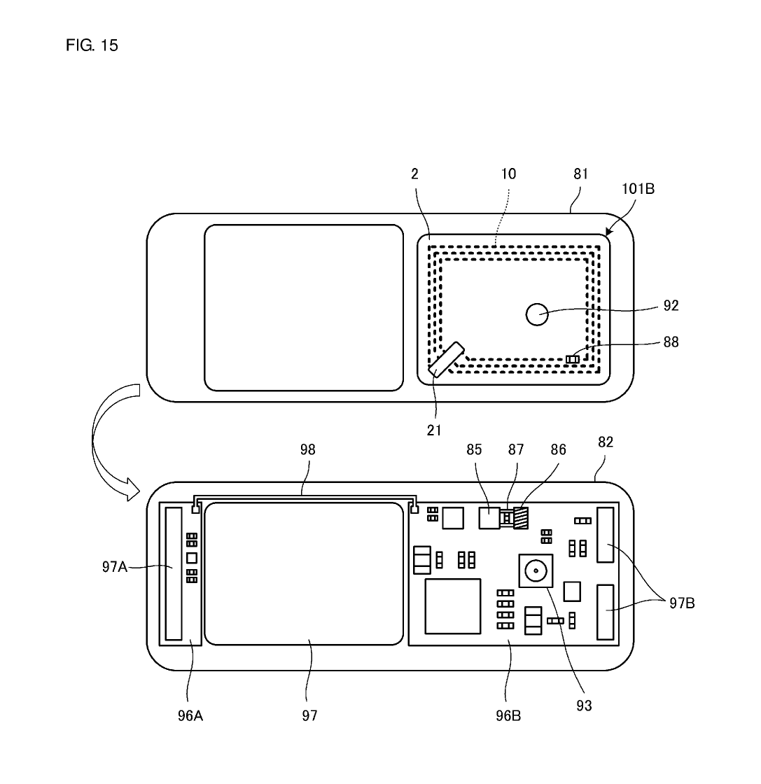

FIG. 15 is a plan view illustrating the structure inside a casing of an electronic appliance according to an eleventh preferred embodiment of the present invention.

The structures of an antenna device and a feeder circuit of a communication terminal device according to the eleventh preferred embodiment are different to those of the communication terminal device of the tenth preferred embodiment and the rest of the configuration is the same or substantially the same as that of the communication terminal device according to the tenth preferred embodiment. Hereafter, the portions that are different from the communication terminal device according to the tenth preferred embodiment will be described.

An antenna device 101B is affixed to the inside of the lower casing 81. The antenna device 101B differs from the antenna device 101 according to the first preferred embodiment in that the antenna device 101B further includes a camera hole 92 and a surface mount device 88. In addition, there is a difference in that the antenna device 101B is not provided with a first external connection terminal, a first external connection terminal plate, a second external connection terminal and a second external connection terminal plate. The surface mount device 88 is mounted on a main surface of the antenna device 101B via conductive joining materials, which are not illustrated. The surface mount device 88 is provided midway along the coil conductor 10. The surface mount device 88 is a chip capacitor of a resonance circuit, for example.

HF band antennas 97B, the feeder circuit 85 including a communication circuit, the surface mount device 87 and a feeder coil 86 that is connected to the feeder circuit 85 are mounted on the circuit board 96B accommodated inside the upper casing 82. The feeder circuit 85 is electromagnetically coupled with the coil conductor 10 of the antenna device 101B via the feeder coil 86.

The configuration of the communication terminal device according to the eleventh preferred embodiment is the same or substantially the same as that of the communication terminal device according to the tenth preferred embodiment and similar actions/effects to those of the communication terminal device according to the tenth preferred embodiment are exhibited with this configuration as well.

In this preferred embodiment, the feeder circuit 85 is electromagnetically coupled with the coil conductor 10 of the antenna device 101B via the feeder coil 86 and therefore the circuit board 96B does not need to be provided with the feeder terminals 83 and 84 that connect the feeder circuit 85 and the coil conductor 10 to each other.

### Other Preferred Embodiments

In the above-described preferred embodiments, examples have been described in which the planar shape of the substrate 1 preferably is rectangular or substantially rectangular, but the planar shape of the substrate 1 is not limited to this configuration. The shape of the substrate 1 may be changed as appropriate to be a polygonal shape, a circular shape, an elliptical shape and so on. In addition, in the above-described preferred embodiments, examples have been described in which the substrate 1 is a flat plate, but the substrate 1 is not limited to this configuration. The thickness of the substrate 1 may be changed as appropriate.

In the above-described preferred embodiments, examples have been described in which the coil conductor 10 is provided on one main surface of the substrate 1, but the coil conductor 10 is not limited to this configuration. A configuration may be adopted in which the coil conductor 10 is provided on the other main surface of the substrate 1 or a configuration may be adopted in which the coil conductor 10 is provided on both surfaces of the substrate 1.

In the above-described preferred embodiments, examples have been described in which the planar shape of the routing member is rectangular or substantially rectangular, but the planar shape of the routing member is not limited to this configuration. The planar shape of the routing member may be changed as appropriate to be a polygonal shape, a circular shape, an elliptical shape and so on. Furthermore, the sectional shape and thickness of the routing member may be changed as appropriate.

In addition, in the above-described preferred embodiments, examples have been described in which the first connection portion and the second connection portion are provided at the two ends of the routing member, but the routing member is not limited to this configuration. The positions of the first connection portion and the second connection portion with respect to the routing member may be changed as appropriate.

Furthermore, in the above-described preferred embodiments, examples have been described in which the planar shapes of the first connection portion and the second connection portion are circular, but the planar shapes of the first connection portion and the second connection portion are not limited to this configuration. The planar shapes of the first connection portion and the second connection portion of the routing member may be changed as appropriate to be a polygonal shape, a circular shape, an elliptical shape and so on.

In the above-described preferred embodiments, antenna devices and electronic appliances of a communication system in which magnetic field coupling such as NFC is utilized have mainly been described, but the antenna devices and electronic appliances according to the preferred embodiments described above are able to be similarly used in non-contact power transmission systems that use magnetic field coupling (electromagnetic induction method or magnetic field resonance method). The antenna devices according to the above-described preferred embodiments are able to be used as a power reception antenna device of a power reception device or a power transmission antenna device of a power transmission device in a non-contact power transmission system of a magnetic field resonance method used at a frequency of a HF band (specifically, 6.78 MHz or in vicinity of 6.78 MHz), for example. The antenna device would be connected to a feeder circuit (power reception circuit) that supplies power to a load (secondary battery) of the power reception device. In this case, the antenna device would function as a power reception antenna device or a power transmission antenna device. The two ends of the coil conductor of the antenna device would be connected to a power reception circuit or a power transmission circuit that operates in the used frequency band (HF band, in particular, 6.78 MHz or in vicinity of 6.78 MHz).

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An antenna device comprising:
a substrate that has an insulating property;
a spiral-shaped coil conductor that is provided on at least one main surface of the substrate; and
a routing member that includes a conductor in at least a portion thereof and a first connection portion and a second connection portion that are electrically connected to each other; wherein
at least a portion of the routing member between the first connection portion and the second connection portion faces the coil conductor;
at least either of the first connection portion and the second connection portion is connected to an inner peripheral portion or an outer peripheral portion of the coil conductor via a conductive joining material;
the routing member includes a flat metal plate; and
a surface of the routing member on a side opposite to a surface thereof on which a protrusion is provided, faces the coil conductor.

2. The antenna device according to claim 1, wherein
the first connection portion is connected to the inner peripheral portion of the coil conductor via a conductive joining material; and
the second connection portion is connected to the outer peripheral portion of the coil conductor via a conductive joining material.

3. The antenna device according to claim 1, wherein a groove is provided in at least a portion of the routing member between the first connection portion and the second connection portion.

4. The antenna device according to claim 1, wherein at least the first connection portion and the second connection portion have a relatively high wettability to the conductive joining materials compared to a region between the first connection portion and the second connection portion.

5. The antenna device according to claim 4, wherein a plating layer is provided on the first connection portion and the second connection portion.

6. The antenna device according to claim 1, wherein the routing member includes a substrate layer that has a same or substantially the same coefficient of linear expansion to the substrate, and a conductor is provided on a surface of the routing member that faces the coil conductor.

7. The antenna device according to claim 1, wherein an insulating layer is provided on at least a portion of the routing member between the first connection portion and the second connection portion.

8. The antenna device according to claim 1, further comprising a surface mount device that is electrically connected to the coil conductor via a conductive joining material.

9. The antenna device according to claim 1, further comprising:
an adhesive layer that is positioned between the routing member and the coil conductor; and
another member that is a member other than the adhesive member and is positioned between the routing member and the coil conductor; wherein
the adhesive layer has a lower dielectric constant than the another member.

10. An electronic appliance comprising:
the antenna device according to claim 1; and
a feeder circuit that is connected to or is electromagnetically coupled with the coil conductor.

11. The electronic appliance according to claim 10, wherein the electronic appliance is one of a phone, a wearable terminal, a computer, a tablet terminal, a personal digital assistance, a camera, a games console and an RFID tag.

12. The electronic appliance according to claim 10, wherein
the first connection portion is connected to the inner peripheral portion of the coil conductor via a conductive joining material; and
the second connection portion is connected to the outer peripheral portion of the coil conductor via a conductive joining material.

13. The electronic appliance according to claim 10, wherein a groove is provided in at least a portion of the routing member between the first connection portion and the second connection portion.

14. The electronic appliance according to claim 10, wherein at least the first connection portion and the second connection portion have a relatively high wettability to the conductive joining materials compared to a region between the first connection portion and the second connection portion.

15. The electronic appliance according to claim 14, wherein a plating layer is provided on the first connection portion and the second connection portion.

16. The electronic appliance according to claim 10, wherein the routing member includes a substrate layer that has a same or substantially the same coefficient of linear expansion to the substrate, and a conductor is provided on a surface of the routing member that faces the coil conductor.

17. The electronic appliance according to claim 10, wherein an insulating layer is provided on at least a portion of the routing member between the first connection portion and the second connection portion.

18. The electronic appliance according to claim 10, further comprising a surface mount device that is electrically connected to the coil conductor via a conductive joining material.

19. The electronic appliance according to claim 10, further comprising:
an adhesive layer that is positioned between the routing member and the coil conductor; and
another member that is a member other than the adhesive member and is positioned between the routing member and the coil conductor; wherein
the adhesive layer has a lower dielectric constant than the another member.
